(19) United States
(12) Patent Application Publication
(10) Pub. No.: US 2012/0098644 A1
(43) Pub. Date: Apr. 26, 2012

(54) METHOD AND APPARATUS FOR VISUALIZING RECOGNITION AREA OF RFID

(75) Inventor: Hoon Young KOO, Seoul (KR)

(73) Assignee: Electronics and Telecommunications Research Institute, Daejeon (KR)

(21) Appl. No.: 13/278,858

(22) Filed: Oct. 21, 2011

(30) Foreign Application Priority Data
Oct. 26, 2010 (KR) 10-2010-0104546

(51) Int. Cl. H04Q 5/22

(52) U.S. Cl. 340/10.1

(57) ABSTRACT

A method and apparatus for visualizing a recognition area of a radio frequency identification (RFID) reader are provided. The recognition area of the RFID reader is visualized by at least one beam indicating a recognition direction, recognition distance, and recognition angle of the RFID reader. The visualized recognition area is adjusted according to actual recognition of the RFID tag.

### CROSS-REFERENCE TO RELATED APPLICATION

This application claims the benefit of Korean Patent Application No. 10-2010-0104546, filed on Oct. 26, 2010, in the Korean Intellectual Property Office, the disclosure of which is incorporated herein by reference.

### BACKGROUND

1. Field of the Invention

The present invention relates to a radio frequency identification (RFID) technology, and more particularly, to a method and apparatus for visualizing an RFID recognition area.

2. Description of the Related Art

A radio frequency identification (RFID) system identifies a tag attached to an object in a non-contact manner, that is, via radio signals, and thereby processes information such as an object name, price, expiration date, or the like. Generally, the RFID is used to automatically recognize objects in the field of physical distribution management.

In general, the RFID system consists of a reader, a reader antenna, and a tag or transponder.

The tag includes a tag antenna and a tag chip. The tag chip is an integrated circuit (IC) that records information.

When the tag gets in the range of a recognition area, the RFID reader transmits a radio signal to the tag by modulating a radio frequency (RF) signal having a specific carrier frequency. When receiving the radio signal, the tag responds to the radio signal. Specifically, the tag chip transmits the recorded information as the radio signal via the tag antenna. The reader antenna receives the radio signal. The reader reads the information using the received radio signal.

Application fields and standard technology of the RFID system are varied according to an operating frequency.

Among a host of frequency bands of the RFID, an ultrahigh frequency (UHF) band provides a high operating frequency. The RFID system using the UHF band is capable of transmission between the RFID reader and an RFID tag over a relatively long distance. In addition, the RFID reader using the UHF band is capable of recognizing a plurality of RFID tags simultaneously. Therefore, the RFID system using the UHF band is being actively used in physical distribution.

In using the RFID system, a user or an operator needs to accurately specify and confirm a range of the recognition area of the RFID tag.

For example, an actual recognition area of the RFID system is narrower than a demanded recognition area, the RFID reader may not recognize the RFID tag although an object attached with the RFID tag is placed in a designated position.

When the actual recognition area is wider than the demanded recognition area, the RFID reader may even recognize other RFID tags, not only an RFID tag to be recognized. According to the use characteristics of the RFID tag, several RFID tags may exist in a specified space. As such, recognition of a wrong RFID tag may cause a serious problem.

Accordingly, there is a desire for a new secure scheme for visualizing the recognition area of the RFID reader.

### SUMMARY

An aspect of the present invention provides an apparatus for visualizing a recognition area of a radio frequency identification (RFID) reader.

Another aspect of the present invention provides an RFID recognition area visualization tuning apparatus and method that visualizes the recognition area of the RFID reader and tunes the visualized recognition area.

According to an aspect of the present invention, there is provided an RFID recognition area visualizing apparatus including an antenna to receive a radio signal from an RFID tag, a reader to read the radio signal received via the antenna, and a first beam output unit to visualize a recognition area of the reader by outputting a beam.

The first beam output unit may output a first beam advancing straight from a center of the antenna in a direction perpendicular to the antenna, thereby visualizing a wave radiation direction of the antenna.

The RFID recognition area visualizing apparatus may further include a second beam output unit to output a second beam, and a convergence point of the first beam and the second beam may indicate a maximum vertical distance of the recognition area of the reader.

The first beam output unit may output a first beam indicating a width of the recognition area of the reader.

The first beam may advance straight, forming a predetermined angle with respect to a direction perpendicular to the antenna.

A plurality of the first beam output units may be provided.

The first beam may have a conical shape.

According to another aspect of the present invention, there is provided an RFID recognition area visualization tuning apparatus including an antenna to receive a radio signal from an RFID tag, a reader to read the radio signal received via the antenna, a visualization module to visualize a recognition area of the reader by outputting at least one beam, and a control unit to control output and activation of the reader and also control the at least one beam output by the visualization module, wherein the antenna may generate radio waves according to the output of the reader.

The control unit may include a visualization table containing information for controlling the at least one beam according to the output of the reader, and control the at least one beam using the visualization table.

The RFID recognition area visualization tuning apparatus may further include a wave reception unit to receive radio waves generated by the antenna. The wave reception unit may transmit receivability of the radio waves and a radio field intensity to the control unit.

The control unit may adjust the visualized recognition area by controlling the visualization module when the wave reception unit exists within the visualized recognition area and is incapable of receiving the radio waves generated by the antenna, or when the wave reception unit exists out of the recognition area and receives the radio waves generated by the antenna.

The control unit may receive, from a user interface, information indicating whether the RFID tag is recognized or not within the visualized recognition area or information indicating whether the RFID tag is recognized out of the visualized recognition area, and control the visualization module based on the information, thereby adjusting the visualized recognition area.

According to another aspect of the present invention, there is provided an RFID recognition area visualization tuning method including setting a default value as a visualization value for generating a visualized recognition area corresponding to an RFID reader and an RFID reader antenna, adjusting an output of the RFID reader based on the visualization value so that the RFID reader has a specific recognition area, and confirming whether an actual recognition area of the RFID reader corresponds to the specific recognition area. The actual recognition area may be visualized by at least one beam based on the visualization value.

The visualized recognition area may be indicated by at least one of a first beam, a second beam, and a third beam. The first beam may advance straight in a direction perpendicular to the antenna from a center of the RFID reader antenna. A convergence point between the first beam and the second beam may indicate a maximum vertical distance of the recognition area of the RFID reader. The third beam may indicate a width of the recognition area of the reader.

The RFID recognition area visualization tuning method may further include revising the visualization value to adjust the recognition area.

The RFID recognition area visualization tuning method may further include revising the visualization value when the RFID tag within the recognition area is not recognized or when the RFID tag out of the recognition area is recognized.

### EFFECT

According to embodiments of the present invention, an apparatus for visualizing a recognition area of a radio frequency identification (RFID) reader is provided.

Additionally, according to embodiments of the present invention, an apparatus and method for visualizing a recognition area of the RFID reader and tuning the visualized recognition area are provided.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for visualizing a radio frequency identification (RFID) recognition area, according to an embodiment of the present invention;

FIG. 2 is a diagram illustrating a recognition area of an RFID reader when a radio wave output is low, according to an embodiment of the present invention;

FIG. 3 is a diagram illustrating a structure of an apparatus for tuning visualization of an RFID recognition area, according to an embodiment of the present invention; and

FIG. 4 is a flowchart illustrating a method for tuning visualization of an RFID recognition area, according to an embodiment of the present invention;

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

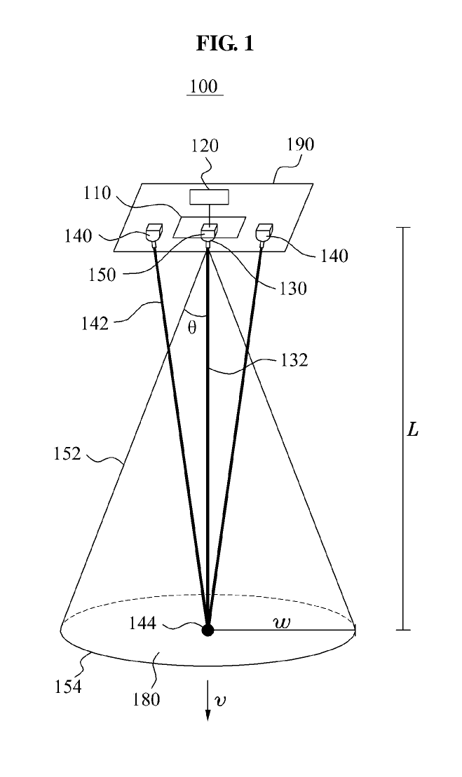

FIG. 1 is a diagram illustrating a radio frequency identification (RFID) recognition area visualizing apparatus 100 according to an embodiment of the present invention.

The RFID recognition area visualizing apparatus 100 includes an antenna 110 and a reader 120.

The antenna 110 receives a radio signal from an RFID tag.

The reader 120 reads the radio signal received via the antenna.

The RFID recognition area visualizing apparatus 100 may include at least one of a first beam output unit 130, a second beam output unit 140, and a third beam output unit 150. In the drawings, the first beam output unit 130 and the third beam output unit 150 are overlapped. The first beam output unit 130, the second beam output unit 140, and the third beam output unit 150 respectively output beams, thereby visualizing a recognition area of the reader 120.

At least one of the antenna 110, the first beam output unit 130, the second beam output unit 140, and the third beam output unit 150 may be attached to one plane 190.

Visualization factors 1) to 3) described in the following may be used to visualize the recognition area of the reader 120.

1) Recognition direction (υ): Visualization of a radio wave radiation direction of the antenna 110

2) Recognition distance (L): Visualization of a maximum vertical distance of the recognition area

The recognition distance is expressed by a convergence point of at least two beams. When convergence of at least two beams is not achieved, a distance between the antenna 110 and a bottom surface 180 is adjusted so that at least two beams converge and the recognition distance is visualized.

3) Recognition angle (θ): In visualization of the recognition area having a radiation pattern, a width of the recognition area is visualized in the form of an angle.

The first beam output unit 130 visualizes the radio wave radiation direction υ of the antenna 110, by outputting a first beam 132 that advances straight in a perpendicular direction to the antenna 110 from a center of the antenna 110.

The second beam output unit 140 outputs a second beam 142. A convergence point 144 of the first beam 132 and the second beam 142 indicates a maximum vertical distance L of the recognition area of the reader 120.

The third beam output unit 150 outputs a third beam indicating an angle θ of the recognition area of the reader 120 and a width ω of the recognition area according to the angle θ.

The third beam may be a beam 152 that advances straight, forming a predetermined angle θ with respect to the perpendicular direction of the antenna 110.

More specifically, the third beam may be a conical beam 154 forming the predetermined angle θ with respect to the perpendicular direction of the antenna 110.

The second beam output unit 140 or the third beam output unit 150 may be plural.

As the recognition area of the reader 120 is visualized, when the RFID tag disposed in a designated position is not recognized by the reader 120, causes of the malfunction may be more easily understood. The causes may include 1) escape of the RFID tag from the recognition area of the reader 120, 2) trouble in sensitivity of the RFID tag, and 3) other environmental factors.

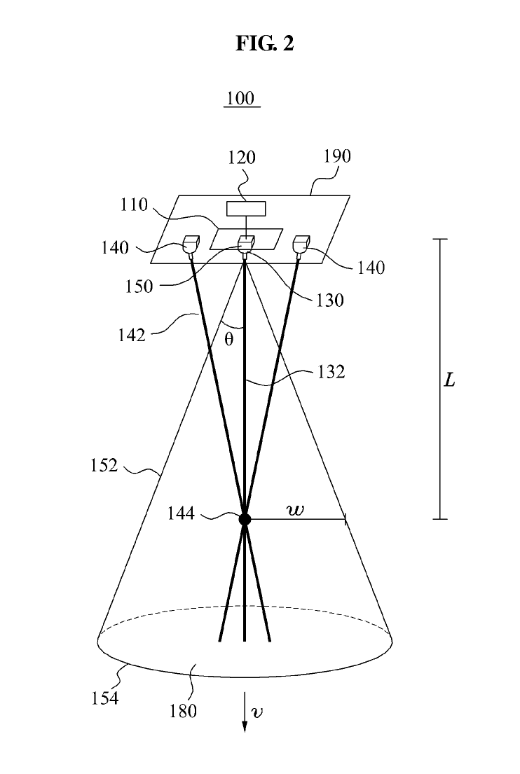

FIG. 2 is a diagram illustrating a recognition area of an RFID reader when a radio wave output is low, according to an embodiment of the present invention.

Here, the radio wave output of the reader 120 is lower in the present embodiment than in the embodiment of FIG. 1.

Therefore, the maximum vertical distance L of the recognition area of the reader 120 is shorter in the present invention than in the embodiment of FIG. 1. The convergence point 144 of the present embodiment is closer to the antenna 110 than in the embodiment of FIG. 1.

In addition, the width ω of the recognition area of the reader 120 is narrower in the present embodiment than in the embodiment of FIG. 1.

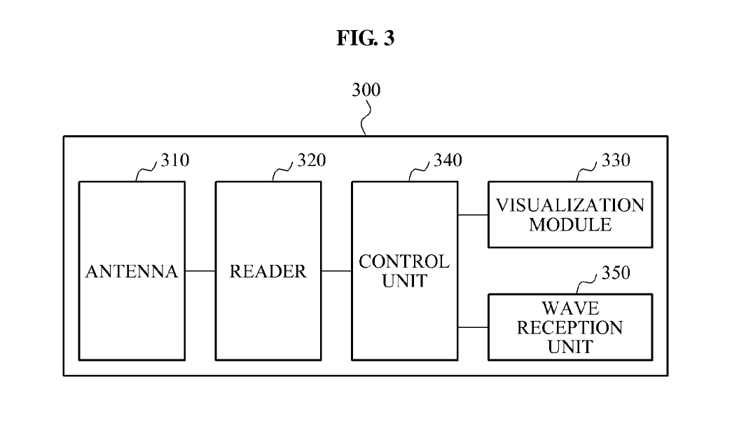

FIG. 3 is a diagram illustrating a structure of an RFID recognition area visualization tuning apparatus 300 according to an embodiment of the present invention.

The RFID recognition area visualization tuning apparatus 300 may include an antenna 310, a reader 320, a visualization module 330, and a control unit 340, and may further include a wave reception unit 350.

The antenna 310 receives a radio signal from an RFID tag.

The reader 320 reads the radio signal received via the antenna 310.

The visualization module 330 outputs at least one beam, thereby visualizing a recognition area of the reader 320. The visualization module 330 may include at least one of the first beam output unit 130, the second beam output unit 140, and the third beam output unit 150 described with reference to FIG. 1.

The antenna 310 generates radio waves according to the output of the reader 320.

The control unit 340 controls the output and activation of the reader 320, and also controls at least one beam output by the visualization module 330.

The control unit 340 may include a visualization table.

The visualization table contains information for controlling the at least one beam of the visualization module 330 corresponding to the output of the antenna 110. The visualization table may store visualization values per output intensity of the reader 130. Specifically, when the output intensity has a particular value, the visualization table may store the visualization values for controlling the visualization module 330 corresponding to the output intensity.

The control unit 340 may control at least one of the visualization module 330 and the at least one beam output by the visualization module 330, by adjusting the output of the reader 320.

The wave reception unit 350 may determine receivability or intensity of the radio waves output from the antenna 310, and transmit the receivability or intensity to the control unit 340.

The recognition area of the reader 320, visualized by the visualization module 330, may be different from a recognition area actually recognizing an RFID tag. Therefore, it is demanded to determine whether the visualized recognition area is appropriate. According to the determination result, tuning of the recognition area visualization may be required.

When the wave reception unit 350 is within the visualized recognition area and incapable of receiving radio waves generated by the reader 320, this state is hereinafter referred to as ‘non-recognition.’ In this case, the control unit 340 may receive information related to the non-recognition, that is, non-recognition information from the wave reception unit 340, and control the visualization module 330 based on the received non-recognition information, thereby adjusting the visualized recognition area. For example, the recognition area may be narrowed. Here, the control unit 340 may adjust or update the visualization value.

When the wave reception unit 350 is within the visualized recognition area and receives the radio waves generated by the antenna 310, this state is hereinafter referred to as ‘wrong recognition.’ In this case, the control unit 340 may receive information related to the wrong recognition, that is, wrong recognition information, from the wave reception unit 340 and control the visualization module 330 based on the received wrong recognition information, thereby adjusting the visualized recognition area. For example, the recognition area may be widened. Here, the control unit 340 may adjust or update the visualization value.

A user may input information on whether an RFID tag disposed in a specific position is recognized by the reader 320, to the control unit 340 through a user interface. The control unit 340 may be informed of whether the specific position is within the recognition area of the reader 320, and control the visualization module 330 using the information. Accordingly, the control unit 340 may adjust or update the visualization value and control the visualized recognition area.

That is, the control unit 340 may receive, from the user interface, information indicating whether the RFID tag is recognized within the visualized recognition area or information indicating whether the RFID tag is recognized out of the visualized recognition area, and control the visualization module 330 based on the received information, thereby adjusting or updating the visualization value and control the visualized recognition area.

In addition, the user may input information on the recognition area for recognition of the RFID tag, the information such as at least one of L, ω, υ and θ described above, directly to the control unit 340 through the user interface. Also, the control unit 340 may adjust or update the visualization unit and control the visualized recognition area, by controlling the visualization module 330 based on the input information.

Through a tuning operation as described in the foregoing, the recognition area may be considered when the reader 320 is installed. Also, during an actual operation of the reader 320, the RFID tag may be recognized more easily and accurately.

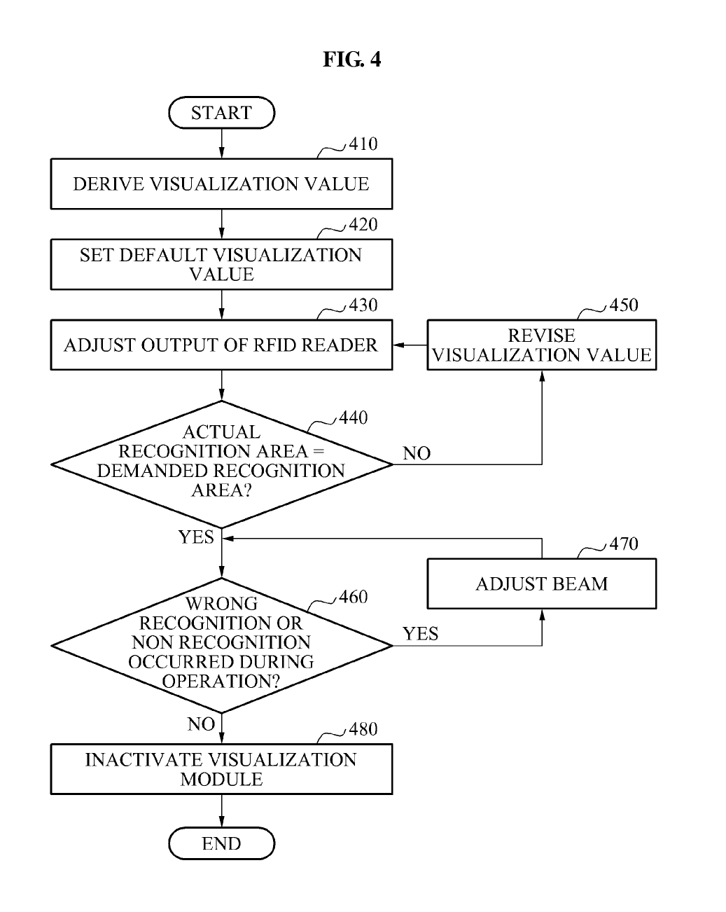

FIG. 4 is a flowchart illustrating a method for tuning visualization of an RFID recognition area, according to an embodiment of the present invention.

The method may be applied when installing and operating the RFID recognition area visualizing apparatus 100 or the RFID recognition area visualization tuning apparatus 300.

In operation 410, a visualization value is derived as a reference for generation of a visualized recognition area corresponding to the RFID reader and the RFID reader antenna.

The visualization value may be measured or derived in an anechoic chamber to minimize environmental influences.

In operation 420, the derived visualization value is set to a default value.

When an RFID recognition device is applied to an actual use environment or when the RFID recognition area visualization tuning apparatus 300 is initially used, an output of the RFID reader needs to be adjusted to achieve a recognition area demanded by a user.

In operation 430, the output of the RFID reader is adjusted based on the default value such that the RFID reader has a specific recognition area.

The recognition area may be visualized by at least one beam output by the visualization module 330 described with reference to FIG. 3. That is, the output is adjusted such that the at least one beam is radiated to the specific recognition area.

In operation 440, it is checked whether an actual recognition area of the RFID reader corresponds to the specific recognition area. Operation 440 may be performed by the wave reception unit 450 described with reference to FIG. 3.

When the actual recognition area does not correspond to the specific recognition area, operation 450 may be performed. When the actual recognition area corresponds to the specific recognition area, operation 460 may be performed.

In operation 450, the visualization value is revised or updated to adjust the specific recognition area such that the actual recognition area corresponds to the specific recognition area. Next, the output of the RFID reader is adjusted according to the revised visualization value. Operation 440 is performed to visualize the recognition area.

Next, the RFID recognition area visualizing apparatus 100 or the RFID recognition area visualization tuning apparatus 300 may be operated to obtain information of the RFID tag.

In operation 460, it is determined whether wrong recognition or non-recognition occurs during the operation of the RFID recognition area visualizing apparatus 100 or the RFID recognition area visualization tuning apparatus 300.

Operation 470 is performed when wrong recognition or non-recognition occurs, and operation 480 is performed otherwise.

The user of the RFID recognition area visualizing apparatus 100 or the RFID recognition area visualization tuning apparatus 300 may learn a cognition operation through the visualized recognition area, and check occurrence of a trouble in recognizing the RFID tag by monitoring whether the RFID tag is recognized.

When the wrong recognition or non-recognition occurs during the operation, adjustment of the visualized recognition area is demanded. Therefore, in operation 470, at least one beam of the RFID recognition area visualization apparatus 100 or the RFID recognition area visualization tuning apparatus 300 is adjusted. The adjustment may be achieved by revising or updating the visualization value. Next, operation 460 is performed again.

In operation 480, the visualization module may be inactivated.

When the RFID tag is normally recognized and the user is informed of the actual recognition area or is physically indicated, the recognition area may not have to be visualized using the beam. In this case, the at least one beam output units 140, 150, and 160 of the RFID recognition area visualization apparatus 100 or the RFID recognition area visualization tuning apparatus 300 may not output beams. However, a particular beam output unit, for example, the first beam output unit 140 may still output the beam.

The technical features according to the embodiment described with reference to FIGS. 1 through 3 may be directly applied to the present embodiment. Accordingly, a detailed description thereof will be omitted.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A radio frequency identification (RFID) recognition area visualizing apparatus comprising:
an antenna to receive a radio signal from an RFID tag;
a reader to read the radio signal received via the antenna; and
a first beam output unit to visualize a recognition area of the reader by outputting a beam.

2. The RFID recognition area visualizing apparatus of claim 1, wherein the first beam output unit outputs a first beam advancing straight from a center of the antenna in a direction perpendicular to the antenna, thereby visualizing a wave radiation direction of the antenna.

3. The RFID recognition area visualizing apparatus of claim 2, further comprising a second beam output unit to output a second beam,
wherein a convergence point of the first beam and the second beam indicates a maximum vertical distance of the recognition area of the reader.

4. The RFID recognition area visualizing apparatus of claim 1, wherein the first beam output unit outputs a first beam indicating a width of the recognition area of the reader.

5. The RFID recognition area visualizing apparatus of claim 4, wherein the first beam advances straight, forming a predetermined angle with respect to a direction perpendicular to the antenna.

6. The RFID recognition area visualizing apparatus of claim 5, wherein a plurality of the first beam output units are provided.

7. The RFID recognition area visualizing apparatus of claim 4, wherein the first beam has a conical shape.

8. A radio frequency identification (RFID) recognition area visualization tuning apparatus comprising:
an antenna to receive a radio signal from an RFID tag;
a reader to read the radio signal received via the antenna;
a visualization module to visualize a recognition area of the reader by outputting at least one beam; and
a control unit to control output and activation of the reader and also control the at least one beam output by the visualization module,
wherein the antenna generates radio waves according to the output of the reader.

9. The RFID recognition area visualization tuning apparatus of claim 8, wherein the control unit comprises a visualization table containing information for controlling the at least one beam according to the output of the reader, and controls the at least one beam using the visualization table.

10. The RFID recognition area visualization tuning apparatus of claim 8, further comprising a wave reception unit to receive radio waves generated by the antenna,
wherein the wave reception unit transmits receivability of the radio waves and a radio field intensity to the control unit.

11. The RFID recognition area visualization tuning apparatus of claim 10, wherein the control unit adjusts the visualized recognition area by controlling the visualization module when the wave reception unit exists within the visualized recognition area and is incapable of receiving the radio waves generated by the antenna, or when the wave reception unit exists out of the recognition area and receives the radio waves generated by the antenna.

12. The RFID recognition area visualization tuning apparatus of claim 8, wherein the control unit receives, from a user interface, information indicating whether the RFID tag is recognized within the visualized recognition area or information indicating whether the RFID tag is recognized out of the visualized recognition area, and controls the visualization module based on the information, thereby adjusting the visualized recognition area.

13. A radio frequency identification (RFID) recognition area visualization tuning method comprising:
setting a default value as a visualization value for generating a visualized recognition area corresponding to an RFID reader and an RFID reader antenna;
adjusting an output of the RFID reader based on the visualization value so that the RFID reader has a specific recognition area; and
confirming whether an actual recognition area of the RFID reader corresponds to the specific recognition area,
wherein the actual recognition area is visualized by at least one beam based on the visualization value.

14. The RFID recognition area visualization tuning method of claim 13, wherein
the visualized recognition area is indicated by at least one of a first beam, a second beam, and a third beam,
the first beam advances straight in a direction perpendicular to the antenna from a center of the RFID reader antenna,
a convergence point between the first beam and the second beam indicates a maximum vertical distance of the recognition area of the RFID reader, and
the third beam indicates a width of the recognition area of the reader.

15. The RFID recognition area visualization tuning method of claim 13, further comprising revising the visualization value to adjust the recognition area.

16. The RFID recognition area visualization tuning method of claim 13, further comprising revising the visualization value when the RFID tag within the recognition area is not recognized or when the RFID tag out of the recognition area is recognized.
